(19) United States
(12) Patent Application Publication
(10) Pub. No.: US 2013/0133907 A1
(43) Pub. Date: May 30, 2013

(54) ELECTRIC TOOL HAVING INPUT/OUTPUT PORT

(71) Applicant: Hsin-Chi CHEN, Taichung City (TW)

(72) Inventor: Hsin-Chi CHEN, Taichung City (TW)

(21) Appl. No.: 13/343,988

(22) Filed: Jan. 5, 2012

(30) Foreign Application Priority Data
Nov. 25, 2011 (TW) 100143404

(51) Int. Cl. B25F 5/00

(52) U.S. Cl. 173/20; 173/217

(57) ABSTRACT

An electric tool includes a housing, a drive mounted inside the housing, a circuit board mounted inside the housing and electrically connected with the drive, a first connection port electrically connected with the circuit board and exposed outside the housing, and a controller. The controller has a second connection port configured corresponding to the first connection port in a way that the second connection port is detachably and electrically connectable with the first connection port. Connecting the second connection port of the controller with the first connection port of the electric tool enables a user to set operating parameters of the electric tool subject to his/her actual needs through the controller so as to control the operating status of the electric tool.

### BACKGROUND OF THE INVENTION

1. Field of the Invention

The present invention relates generally to electric tools, and more particularly, to an electric tool having an exposed input/output port (hereinafter referred to as “I/O port”) and an external controller.

2. Description of the Related Art

A conventional electric tool, such as electric driller, electric screwdriver and electric wrench, generally comprises a housing, a motor mounted inside the housing, a rotary shaft driven by the motor, a circuit board electrically connected with the motor, and a switching unit mounted to the housing and electrically connected with the motor. The switching unit may comprise a plurality of buttons or a multistage switch for enabling the user to control the revolution speed of the rotary shaft, the time of operation of the electric tool and/or the frequency of operation of the electric tool.

However, the above-mentioned conventional electric tool limits the user in choosing an operation status of the electric tool in default parameters. In other words, the user is prohibited to freely control the operating parameters of the conventional electric tool. Therefore, it is desired to have an improved electric tool, which allows the user to control the operating parameters thereof.

### SUMMARY OF THE INVENTION

The present invention has been accomplished in view of the above-noted circumstances. It is therefore one objective of the present invention to provide an electric tool having an I/O port, which enables the user to control the operating status thereof according to his/her need.

To achieve the above-mentioned objective, the electric tool with an I/O port provided by the present invention comprises a housing, a drive mounted inside the housing, a circuit board mounted inside the housing and electrically connected with the drive, a first connection port electrically connected with the circuit board and exposed outside the housing, and a controller having a second connection port configured to be detachably and electrically connectable with the first connection port. The controller is able to controller the operating parameters of the drive. When the user wants to adjust the operating status of the electric tool, the user can connect the second connection port of the controller with the first connection port of the housing to enable the controller to be electrically connected with the circuit board, such that the user may use the controller to set the operating parameters, such as revolution speed, operating time and operating frequency, of the electric tool. As a result, the user can freely control the operating status of the electric tool.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic perspective view of an electric tool according to a preferred embodiment of the present invention;

FIG. 2 is an exploded view of the electric tool of the preferred embodiment of the present invention, in which a power supply and a controller are removed for concisely illustrating the electric tool; and

FIG. 3 is a block diagram of the electric tool of the preferred embodiment of the present invention.

### DETAILED DESCRIPTION OF THE INVENTION

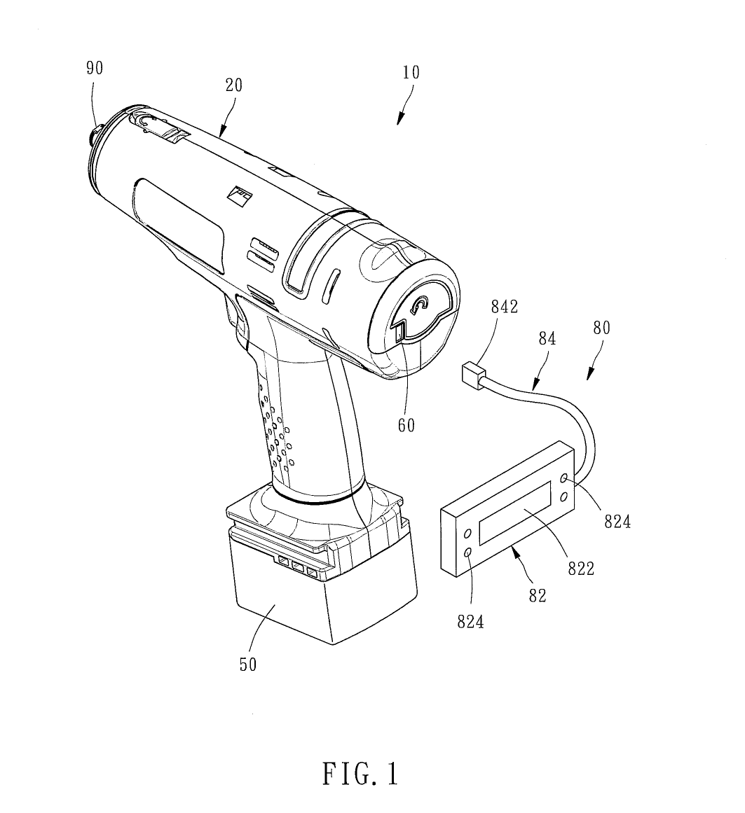

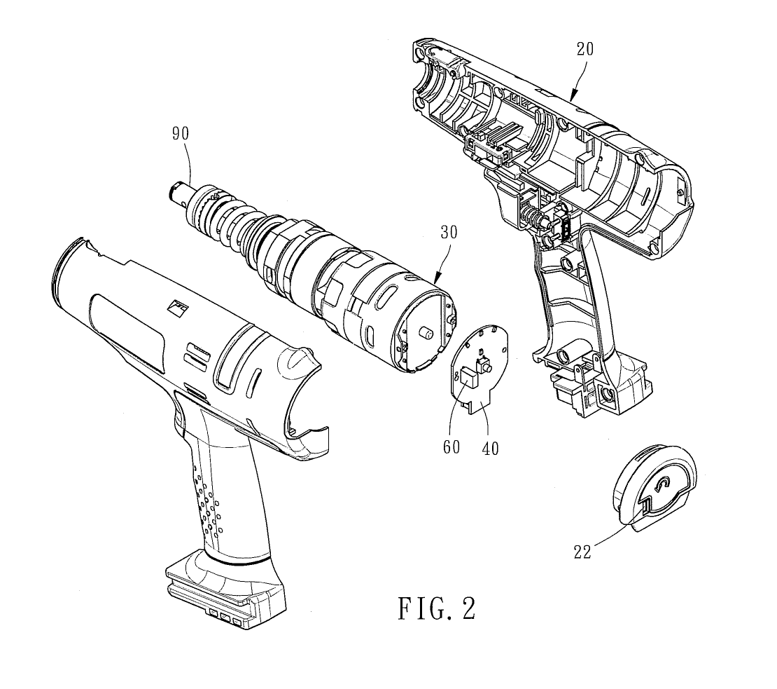

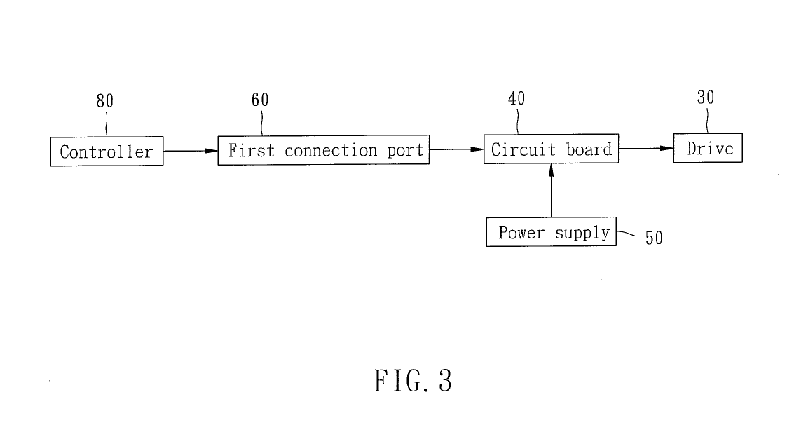

As shown in FIGS. 1-3, an electric tool, provided by a preferred embodiment of the present invention and denoted with reference numeral 10 in the drawings, comprises a housing 20, a drive 30, a circuit board 40, a power supply 50, a first connection port 60, and a controller 80.

The drive 30 is mounted inside the housing 20 and is realized in this preferred embodiment of the present invention by a brushless motor which can output a rotary power to a shaft 90 for driving a working head that is fitted with an end of the shaft 90, which is exposed outside the housing 20, to rotate. Generally, the working head can be, but not limited to, a drill bit, a screwdriver bit or a socket for tightening up a nut. In addition, the drive 30 is not limited to the aforesaid brushless motor.

The circuit board 40 is mounted inside the housing 20 and electrically connected with the drive 30. The power supply 50 is installed at a bottom of the housing 20 for providing the electricity power needed for operating the drive 30. The first connection port 60 is electrically connected with the circuit board 40 and provided with an end exposed outside the housing 20 through a through hole 22 of the housing 20. It is to be noted that ‘the first connection port 60 is exposed outside the housing 20’ doesn't mean that the first connection port 60 must extend out of the housing 20, but the first connection port 60 is accessible without opening or dismantling the housing 20. In addition, the first connection port 60 can be, but not limited to, a port of universal serial bus (hereinafter referred to as “USB”).

The controller 80 includes a main body 82 and a cable 84 fixedly or detachably connected to the main body 82. The cable 84 is provide at an end thereof with a second connection port 842 that is configured corresponding in shape to the first connection port 60 in such a way that the second connection port 842 is detachably and electrically connectable with the first connection port 60. When the user wants to adjust the operating status of the electric tool 10 of the present invention, the user can connect the second connection port 842 with the first connection port 60 to enable the controller 80 to be electrically connected with the circuit board 40, which in turn enables the user to set the operating parameters, such as the revolution speed, operating time and operating frequency. After the operating parameters of the electric tool 10 are completely set, the user can detach the second connection port 842 from the first connection port 60, i.e. detach the controller 80 from the housing 20 of the electric tool 10.

In the preferred embodiment of the present invention, the controller 80 includes a display unit 822 and four buttons 824. The user can use these buttons 824 to switch the content shown on the display unit 822 such that the display unit 822 may show the serial number of the electric tool 10, a total time of operation of the electric tool 10, a total frequency of operation of the electric tool 10, a value of an accumulative frequency of operation, or the revolution speed of the drive 30. In these buttons, one of the buttons 824 is designed to be capable of resetting the data shown on the display unit 822 to zero. Specifically speaking, when the display unit 822 shows the value of accumulative frequency of operation, e.g. accumulative frequency of tightening up nuts, the user can push one of the buttons 824 to reset the aforesaid value to zero, such that the controller 80 may restart counting the accumulative frequency of operation of the electric tool 10. In addition, two of the buttons are designed to be capable of increasing and decreasing the value of an operating parameter respectively. For example, when the display unit 822 shows the current revolution speed of the drive 30, the user can push one of the buttons 824 to increase the revolution speed of the drive 30, or another one to decrease the revolution speed of the drive 30.

In conclusion, by means of the feature of the electric tool 10 of the present invention, the user can more freely control the operating status of the electric tool 10. In addition, one controller 80 can be used for setting the operating parameters of various electric tools 10 by turn. That is, every electric tool 10 of the present invention does not need to be equipped with one controller 80 since a plurality of electric tools 10 can commonly use a same controller 80.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electric tool, comprising:
a housing;
a drive mounted inside the housing;
a circuit board mounted inside the housing and electrically connected with the drive;
a first connection port electrically connected with the circuit board and exposed outside the housing; and
a controller having a second connection port configured to be detachably and electrically connectable with the first connection port.

2. The electric tool of claim 1, wherein the drive is a brushless motor.

3. The electric tool of claim 1, wherein the first connection port is a USB port.

4. The electric tool of claim 1, wherein the controller comprises a display unit for showing a serial number of the electric tool, a total time of operation of the electric tool, or a total frequency of operation of the electric tool.

5. The electric tool of claim 1, wherein the controller comprises a display unit for showing a value of an accumulative frequency of operation counted by the controller, and a button for being pushed to reset the value to zero.

6. The electric tool of claim 1, wherein the controller comprises a display unit for showing a current revolution speed of the electric tool, a first button for being pushed to increase the current revolution speed, and a second button for being pushed to decrease the current revolution speed.

7. An electric tool for being electrically connected with an external controller, the electric tool comprising:
a housing;
a drive mounted inside the housing;
a circuit board mounted inside the housing and electrically connected with the drive; and
a first connection port electrically connected with the circuit board and exposed outside the housing for being detachably and electrically connected with the external controller for enabling the electric tool to be electrically connected with the external controller.

8. The electric tool of claim 7, wherein the drive is a brushless motor.

9. The electric tool of claim 7, wherein the first connection port is a USB port.
